(19) United States
(12) Patent Application Publication
(10) Pub. No.: US 2026/0266549 A1
(43) Pub. Date: Sep. 10, 2026

(54) THERMAL MANAGEMENT AIR DUCT FOR AIRBORNE FUEL CELL SYSTEMS

(71) Applicant: SAS BEYOND AEROSPACE, Cugnaux (FR)

(72) Inventors: Valentin CHOMEL, Cugnaux (FR); Flavio ACCORINTI, Cugnaux (FR); Yuchen LENG, Cugnaux (FR); Matthieu Pettes DULER, Cugnaux (FR)

(73) Assignee: SAS BEYOND AEROSPACE, Cugnaux (FR)

(21) Appl. No.: 19/489,253

(22) PCT Filed: May 31, 2024
(86) PCT No.: PCT/EP2024/065119

§ 371 Date: Dec. 1, 2025

(30) Foreign Application Priority Data
May 31, 2023 (FR) FR2305468

(51) Int. Cl. F28D 1/00; B64C 1/00; B64D 27/34; B64D 27/355; B64D 29/04; B64D 33/10; F28D 21/00; H01M 8/04014

(52) U.S. Cl. CPC F28D 1/00; B64C 1/00; B64D 27/34; B64D 27/355; B64D 29/04; B64D 33/10; F28D 21/00; H01M 8/04014; F28D 2021/0043; H01M 2250/20

(57) ABSTRACT

The present invention relates to an aircraft comprising a cooling system integrated into the fuselage, and at least one propeller driven by an electric motor adapted to propel the aircraft, the cooling system comprising:
at least one cooling duct (or air duct), installed inside the fuselage of the aircraft, provided with an air inlet and an air outlet, the cooling duct being designed to allow air to flow between the air inlet and the air outlet;
at least one heat exchanger positioned inside the cooling duct, the heat exchanger being designed to transfer thermal energy to the air flowing in the cooling duct;
   wherein the air inlet is positioned in an area of overpressure generated by the air accelerated by the rotation of the propeller, and the air outlet is strategically positioned on an outer surface of the fuselage passed over by the air flow accelerated by the rotation of the propeller, generating an area of lower pressure facilitating the flow of air through the cooling duct, thereby allowing efficient dissipation of heat through the heat exchanger.

### TECHNICAL FIELD OF THE INVENTION

The present invention relates to an aircraft, more specifically an aircraft propelled by electric motors powered by a hydrogen fuel cell. The invention is notably applicable with electric aircraft and notably with airplanes implementing the described invention.

### PRIOR ART

Current aircraft, and more specifically airplanes, are propelled from the energy produced by the combustion of kerosene. Civil aviation is responsible for emitting a significant amount of greenhouse effect gases, including carbon dioxide. It is imperative that alternative solutions are developed that do not produce any or only a small amount of greenhouse effect gases. Electrically propelled aircraft offer a solution for reducing greenhouse effect gases emitted by civil aviation. The use of batteries is not optimal in terms of their weight. The electric propulsion solution that is powered by a hydrogen fuel cell offers a possible solution for replacing batteries.

The thermal management of the hydrogen fuel cell is a key factor for the correct operation of the fuel cell. One of the problems of electric propulsion powered by a hydrogen fuel cell resides in the cooling of the fuel cell. Indeed, a fuel cell is more efficient than an internal combustion engine, but the heat generated by a fuel cell, for example of the PEM (Proton Exchange Membrane) type, is significant. From 50 to 60% of the energy produced by the fuel cell is in the form of thermal energy and therefore in the form of heat to be discharged. In addition, in order to operate efficiently, LT (Low Temperature) type fuel cells must be maintained at low temperatures, of the order of 80° C.

Thus, properly cooling the fuel cell is a decisive factor in allowing them to be used properly and not reducing their service life.

Cooling systems are already provided for aviation. A heat-transfer fluid (liquid or vapor) flowing between the device to be cooled and a heat exchanger can be provided. The heat exchanger is arranged in a cooling duct with an air inlet, also called scoop, and an air outlet. Due to the movement of the airplane, the scoop admits the outside air that circulates in the cooling duct, then passes through the heat exchanger. The heat exchanger transfers heat energy from the heat-transfer fluid to the heated air, which is then discharged through the air outlet.

These cooling systems are notably designed to cool the electronics present on board aircraft.

However, in order to discharge the thermal energy produced by a fuel cell used to power the electric motors for propelling an aircraft, the dimensions of these heat exchange systems must be significant. Indeed, the greater the amount of heat to be discharged, the greater the air flow that needs to be provided. In order to have greater air flows, larger air inlets generally need to be provided, as well as air ducts that are dimensioned accordingly, which has negative consequences on the aerodynamics, and more specifically on the drag of the aircraft and the mass of the aircraft that has to be moved.

Thus, the current solutions for discharging significant amounts of heat, notably originating from fuel cells, in an aircraft have significant disadvantages for aerodynamics, in terms of an increase in drag, the aerodynamics and the mass of the aircraft.

The present invention aims to at least partly overcome these disadvantages.

### SUMMARY OF THE INVENTION

The present invention relates to an aircraft comprising a cooling system integrated into the fuselage, and at least one propeller driven by an electric motor adapted to propel the aircraft, the cooling system comprising:
at least one cooling duct (or air duct), installed inside the fuselage of the aircraft, provided with an air inlet and an air outlet, the cooling duct being designed to allow air to flow between the air inlet and the air outlet;
at least one heat exchanger positioned inside the cooling duct, the heat exchanger being designed to transfer thermal energy to the air flowing in the cooling duct;
   wherein the air inlet is positioned in an area of overpressure generated by the air accelerated by the rotation of the propeller, and the air outlet is strategically positioned on an outer surface of the fuselage passed over by the air flow accelerated by the rotation of the propeller, generating an area of lower pressure facilitating the flow of air through the cooling duct, thereby allowing efficient dissipation of heat through the heat exchanger.

The aim of these arrangements is to ensure that a sufficient flow rate is provided for cooling, while minimizing the impact of the exchanger on drag, by reducing the induced pressure drop. To this end, it is crucial that the available pressure difference is greater than the pressure drop generated by the heat exchanger and the pressure drop of the cooling duct itself. The greater this pressure difference, the less the pressure drop of the exchanger affects drag. The thermal load is then discharged with less impact on the aerodynamics of the aircraft.

An aircraft is understood to mean any vehicle capable of moving in the air, and notably an airplane, a helicopter, etc.

A fuselage is understood to mean any type of main structure of an aircraft. For example, the fuselage can be made up of a monocoque or semi-monocoque structure, or even of a structure with frames and spars. The fuselage can assume various shapes and sizes, adapted to various types of aircraft, whether they are airliners, business jets, small propeller airplanes, military airplanes, drones or helicopters, yet without being limited to these categories.

A cooling system is understood to mean any system for discharging thermal energy by means of a heat exchanger.

A cooling duct, or even a cooling line, is understood to mean a duct or a line allowing a flow of fresh air from outside. The fresh air is admitted via a scoop, also called air inlet, and is discharged via an air outlet. The cooling duct can assume any shape used in aeronautics for cooling ducts, but is not limited to the existing shapes. The cooling duct can be made of carbon, made of metal material, such as, for example, aluminum and its alloys, or any type of composite material (such as, for example, material based on carbon fibers, glass fiber), technical plastics, polymers, technical ceramics.

The duct can have branches called splitters, these are separations in the duct allowing the flow to separate into two or more sub-flows upstream or downstream of the heat exchanger. The latter can be vertical, horizontal or in any other geometric configuration.

A heat exchanger is understood to mean a device allowing heat to be transferred between two or more fluids, of any nature, at different temperatures. The fluids can be separated by a solid wall in order to prevent them from mixing or coming into direct contact. One of the fluids, generally at a higher temperature, yields heat to the other fluid, thus resulting in the cooling or heating of the fluid in question.

A two-phase heat exchanger (evaporator and condenser) is also an option for a heat exchanger. In this type of heat exchanger, one of the fluids yields latent heat by changing phase (condensation or evaporation), while the other fluid heats up or cools down.

The heat exchangers can assume various shapes, dimensions and materials.

The heat exchanger can, for example, cool a heat-transfer fluid, liquid, vapor or gas with the air flowing in the duct. The heat exchanger can also directly admit the thermal energy on the device to be cooled by pure thermal conduction or by using any passive device with capillary or non-capillary pumping such as heat pipes or vapor chambers. The heat exchanger can transfer thermal energy to the air in the duct by any means, notably by means of fins, pins, cones, broken fins, funnels, etc., and with any type of cross-section such as, for example, a triangular, cylindrical, rectangular cross-section, etc.

Transferring thermal energy to the air is understood to mean that heat is transferred to the air through contact with the heat exchanger.

A thruster, propeller, fan or ducted fan adapted to propel the aircraft is understood to mean a propeller that allows the aircraft to advance. It can be a thrust or propulsion propeller. The propeller comprises blades that are also called vanes. This thruster can be actuated by an electric motor.

An electric motor is understood to mean any type of device that converts electrical energy into rotary mechanical energy. In this case, this electric motor is adapted to the propulsion of an aircraft.

An operating thruster is understood to mean that the propeller produces enough force to have an impact on the movement of the aircraft.

When a thruster is a propeller, the areas of pressure are distributed as follows:
area of negative pressure in front of the propeller: when the propeller rotates, it creates an area of low pressure or of negative pressure in front of the propeller. It is this negative pressure that draws the air toward the propeller;
area of overpressure behind the propeller: as the air is pushed rearward by the propeller, its pressure increases. This creates an area of high pressure or of overpressure behind the propeller. It is this expulsion of high pressure air that generates the thrust that propels the airplane forward.

When a thruster is an electric ducted fan, the areas of pressure are distributed as follows:
area of negative pressure at the inlet: when the air is sucked into the nacelle fairing, an area of low pressure or of negative pressure forms at the inlet of the duct. It is this negative pressure that draws the air into the system;
area of overpressure in the duct: as the air is accelerated by the fan blades, its pressure increases. This creates an area of high pressure or of overpressure in the duct;
area of negative pressure behind the fan: immediately behind the fan blades, another area of negative pressure is formed. This is due to the acceleration of the air by the fan, which “pulls” the air behind it;
area of overpressure at the outlet: the high pressure air in the duct is ultimately expelled behind the EDF (Electric Ducted Fan), creating another area of overpressure.

An air inlet is understood to mean any type of air inlet used in aeronautics for cooling systems, yet without being limited to these types. For example, the air inlet can be made up of several openings leading into the cooling duct.

The air inlet is positioned at a site of high air pressure as the airplane advances, for example in the vicinity of the nose of the airplane or on one side, below or above the fuselage, or even on a wing, on the root of the wing or at the base of the fin, or on a pylon holding a nacelle, etc.

The air inlet can be arranged in an area located downstream of the thruster, so that a portion of the air accelerated thereby is directed into the cooling duct or more generally so that it benefits from an area of overpressure. This air inlet can be directly located in the air flow or over an area of overpressure, or so that a portion of the air flow is diverted by a dedicated device. In other words, the propeller allows air to be blown into the duct in order to accelerate the flow thereof.

When the thruster is a ducted fan, then the air inlet can be located in the nacelle, downstream of the propeller.

An air outlet is understood to mean any type of air outlet used in aeronautics for cooling systems, yet without being limited to these types. For example, the air outlet can be made up of a plurality of openings from the cooling duct. Furthermore, a plurality of air outlets can be provided, each corresponding to a bifurcation of the cooling duct. The duct can have one or more outlets, thus a plurality of ducts can have a single common outlet.

The air outlet can be placed in an area of low pressure generated by the thruster, either upstream (when the air is sucked in), or downstream (immediately behind the blades of the fan, following the acceleration of the air by the thruster, which “sucks in” the air behind it) or, via a suction Venturi effect, on the areas of the fuselage or of the nacelle where the air flow speed increases due to the action of the thruster. In other words, the propeller allows the air contained in the duct to be sucked in so as to accelerate its flow.

Positioning the air outlet in an area of negative pressure of the fuselage or of the nacelle increases the available pressure differential.

Positioning the air inlet in an area of overpressure of the fuselage or of the nacelle increases the available pressure differential.

An increase in the available pressure differential allows, for example, a potentially greater pressure drop to be overcome. This pressure drop can be due to the geometry of the duct or to a heat exchanger with a larger contact surface with the air. Consequently, this can improve the discharging of the thermal energy, thus increasing the efficiency of the cooling system.

The greater the amount of heat to be dissipated, the greater the air flow required to dissipate it, the greater the pressure drop caused by the heat exchanger. This situation results in a significant reduction in the difference between the available pressure jump and the pressure drop that is introduced and consequently results in aerodynamic drag that is detrimental to the aircraft.

The air inlet is positioned at a site of greater air pressure as the airplane advances relative to the air outlet, for example in the front part of the airplane.

The air outlet is positioned at a site of lower air pressure as the airplane advances relative to the air inlet, for example in the rear part of the airplane.

The air inlet can comprise a movable part that moves as a function of the requirement for an air flow for cooling the exchanger. For example, the air inlet can include a valve or modulation flaps or one or more deflectors that open more or less depending on the required air flow.

The air outlet can comprise a movable part that moves as a function of the requirement for an air flow for cooling the exchanger. For example, the air outlet can include a valve or modulation flaps or one or more deflectors that open more or less depending on the required air flow.

In front of or upstream of the propeller is understood to mean in front of a plane attached to the reference frame of the aircraft and in which the propeller moves. In front of this plane is understood to mean on the side where the air flow passing through the propeller arrives when the propeller is operating. Within the context of an airplane, in front of the propeller means positioned on the side of the plane that is located on the side of the nose of the airplane.

Behind or downstream of the propeller is understood to mean in front of a plane attached to the reference frame of the aircraft and in which the propeller moves. Behind this plane is understood to mean on the side where the air flow passing through the propeller is accelerated when the propeller is operating. Within the context of an airplane, behind the propeller means positioned on the side of the plane that is located on the side of the tail cone of the airplane.

A circle circumscribed on the propeller is understood to mean the circle, in a fixed reference frame relative to the airplane, formed by a series of small outlets positioned on the inner wall of the nacelle in correspondence with the tips of the blades. It is also the circle passing through all the tips of the propeller and having the center of the propeller as its center.

Positioned in an area in front of the propeller so that the air exiting the air outlet at least partially passes through a circle circumscribed on the propeller, or in a plane parallel to this circumscribed circle upstream of the propeller when the propeller is operating, is understood to mean that the outlet is positioned so as to be in an area where the propeller produces a negative pressure when it is operating. Thus, when the propeller is operating, the air flow exiting the cooling duct exits in an area of negative pressure generated by the propeller, which generates a negative pressure at the outlet of the cooling duct. In other words, the area is defined as an area where the air pressure is lower when the propeller is operating.

Positioned in an area behind the propeller so that the air entering the air inlet at least partially passes through a circle circumscribed on the propeller when the propeller is operating is understood to mean that the inlet is positioned so as to be in an area where the propeller produces an overpressure when it is operating. Thus, when the propeller is operating, the air flow enters the cooling duct from an area of overpressure generated by the propeller, which generates an overpressure at the inlet of the cooling duct. In other words, the area is defined as an area in which the air pressure is higher when the propeller is operating.

An electric fan is understood to mean any type of mechanical device powered by electricity that is designed to move air.

The fan is powered by the electrical generation system of the aircraft that it helps to cool. This means that some of the electrical energy produced by the system is used to operate the fan. However, this energy consumption is compensated for by increasing the efficiency of the cooling system, which allows a safe and effective operating temperature to be maintained for the entire propulsion system of the aircraft.

A fan in the duct is understood to mean a mechanical device integrated inside the cooling duct. This fan, which can be made up of a propeller or a plurality of fins, is specifically designed to accelerate the movement of the air through the duct. Its main role is to promote heat exchange by increasing the air flow through the heat exchanger, thus optimizing the efficiency of the cooling system.

The fan can be positioned at various points along the duct. For example, it can be placed upstream of the heat exchanger, i.e., before the exchanger in the direction of the air flow. This allows the air to be pushed through the exchanger, thus increasing the amount of thermal energy that can be transferred from the exchanger to the air.

Alternatively, the fan can be positioned downstream of the heat exchanger, or after the exchanger in the direction of the air flow. In this case, the fan sucks the air through the exchanger, which can be particularly useful for maintaining the air flow in situations where the air pressure at the outlet of the duct is low.

If the system comprises a plurality of heat exchangers, one or more fans can be installed between these exchangers. This configuration optimizes the pressure jump through each exchanger, thus increasing the overall efficiency of the cooling system. This type of configuration of the fans is thus defined as “in series”.

A plurality of smaller fans can be installed next to each other to ensure that the correct air flow flows through the exchanger. This type of configuration of the fans is thus defined as “in parallel”.

The fan can comprise a movable part that moves as a function of the requirement for an air flow for cooling the exchanger. For example, the rotation speed of the fan can be modulated as a function of the required air flow, or the fan blades can be oriented so as to optimize the performance capabilities of the fan as required. A combination of these two approaches is also possible.

In terms of positioning, the fan can be mounted axially, i.e., aligned with the air flow flowing in the duct, or radially, i.e., perpendicular to the air flow. Each of these configurations offers specific advantages. For example, mounted axially (axial inlet, axial outlet) provides a greater air flow and a homogeneous distribution of the air flow, promoting an even exchange of heat over the entire exchanger. This type of fan promotes the flow with respect to the pressure jump and is used when the air flow to be supplied is high and the pressure jump to be provided is lower. Conversely, mounted radially (axial inlet, radial outlet) is useful when the pressure jump to be provided is greater compared to the required air flow.

The size and shape of the fan also can vary as a function of the specific features of the cooling duct and of the heat exchanger. For example, in a small diameter duct, a fan with short and inclined blades can be favored in order to maximize the air flow. Conversely, in a wider duct, a fan with long and straight blades can be used in order to generate a more powerful air flow.

Finally, the fan can be equipped with regulation and control devices, allowing its operation to be adjusted in real time as a function of the flight conditions, the performance capabilities of the electric thruster and the cooling requirements. These devices can include temperature and pressure sensors, rotation speed controllers, and blade control systems. This technological sophistication helps to optimize the performance of the cooling system, while minimizing the impact on the energy efficiency and aerodynamics of the aircraft.

According to one embodiment, the cooling system is used to cool a fuel cell.

The LT (Low Temperature) type fuel cells generate a significant amount of heat and need to be maintained at controlled temperatures. Thus, such a cooling system is all the more suitable for cooling hydrogen fuel cells.

According to one embodiment, the cooling duct is positioned in the fuselage of the aircraft.

This improves the aerodynamics of the aircraft.

According to one embodiment, the aircraft further comprises a fairing (a nacelle) where the propeller and the air outlet are positioned.

A nacelle fairing for an electric ducted fan improves the efficiency of the propeller and ensures that the air outlet is entirely and stably placed in an area of negative pressure. Indeed, the fairing of the nacelle ensures the stability of the area of negative pressure located in front of the propeller, by placing the air outlet in the fairing of the nacelle, in front of the propeller, this ensures that the air outlet is permanently positioned in the area of negative pressure.

The nacelle of a ducted fan is understood to mean the part surrounding the propeller and improving the efficiency thereof. The fairing is an element of the nacelle (also called “duct”). The propeller is attached to the nacelle and the motor of the propeller is arranged in the nacelle. The air outlet is positioned on the inner wall of the fairing.

According to one embodiment, the air outlet has a plurality of openings distributed over the entire inner circumference of the nacelle.

According to one embodiment, the air outlet could be positioned behind the nacelle, in an area of negative pressure generated by the acceleration of the air. This configuration would allow this negative pressure to be used to facilitate the discharging of the hot air from the cooling system, while minimizing the impact on the drag of the aircraft.

This avoids the periodic imbalance of the mechanical load on the propeller, i.e., having locations where greater force is applied to the propeller. These distortions reduce the efficiency of the motor.

Openings distributed over the entire inner circumference of the nacelle is understood to mean that the openings are arranged substantially symmetrically relative to the center of the propeller, i.e., arranged according to a central axial symmetry of the center of the propeller. For example, the openings can be arranged substantially continuously along the inner circumference of the fairing. Not all the openings can have the same diameter as a function of the balancing of the air flow in each opening.

According to one embodiment, the cooling duct comprises a second air outlet and the aircraft further comprises a second propeller positioned in a second fairing, and wherein the second air outlet is positioned in front of the second propeller in a second fairing.

Thus, two air outlets are provided to discharge the air entering the cooling duct. These two air outlets are both respectively arranged in the areas of negative pressure generated by the propeller and the second propeller. Thus, the air contained in the duct is sucked in by two propellers, which even further accelerates the flow of air in the cooling duct.

According to one embodiment, the reaction products from the fuel cell are injected under pressure into the cooling duct upstream of the heat exchanger and toward the air outlet.

This accelerates the ejection of the air contained in the duct and thus improves the efficiency of discharging the thermal energy supplied by the heat exchanger.

A reaction product is understood to mean the elements produced by the oxidation reaction when the fuel cell produces electricity. In the case of a hydrogen combustion cell, the products of the reaction producing electricity are mainly water vapor.

According to one embodiment, the air inlet can be equipped with an adjustable flap system, allowing the amount of incoming air to be modulated as a function of the cooling requirements. These flaps, by opening and closing, can control the air flow entering the cooling duct and thus optimize the efficiency of the cooling and the resulting aerodynamic drag as a function of the flight conditions and of the thermal load of the system.

In yet another embodiment, the air inlet can comprise an internal duct system configured to optimally direct air toward the heat exchanger. These ducts can be designed to minimize the pressure drop and maximize the efficiency of the heat exchange.

According to one embodiment, the air inlet could be configured to collect air not only from the front, but also from the sides, using auxiliary ducts. This configuration could increase the air flow available for cooling, while allowing greater flexibility for positioning the air inlet on the fuselage.

According to one embodiment, the air outlet can be equipped with an adjustable flap system, allowing the amount of incoming air to be modulated as a function of the cooling requirements. These flaps would allow the air flow exiting the cooling duct to be controlled, thus optimizing the efficiency of the cooling and the aerodynamic drag as a function of the flight conditions and of the thermal load of the system.

According to one embodiment, the air outlet could comprise a plurality of openings strategically placed along the fuselage in order to optimize the air distribution and minimize the disturbance of the air flow around the aircraft.

According to one embodiment, the air outlet could be designed to direct the outgoing air so as to minimize the impact on the aerodynamics of the aircraft. For example, the air could be directed so as to optimally mix with the air flow around the aircraft, thus minimizing drag.

According to one embodiment, the air outlet could be designed to direct the outgoing air so as to assist the propulsion of the aircraft. Although this effect would probably be minimal, it nevertheless could contribute to the overall efficiency of the aircraft.

According to one embodiment, the fan in the duct can be associated with an electronic or mechanical speed variator. This speed variator allows the rotation speed of the fan to be precisely adjusted as a function of the cooling requirements, thus minimizing electrical consumption, while providing adequate cooling of the system.

According to one embodiment, the fan in the duct can be equipped with variable pitch blades. This allows the angle of the blades to be dynamically adjusted as a function of the flight conditions and of the cooling requirements. Thus, the fan can provide an optimum air flow irrespective of the flight conditions.

According to one embodiment, the fan in the duct can be configured to operate in reversible mode. In other words, it can reverse the direction of its air flow, which can be useful for rapidly dissipating the heat accumulated in the duct in the event of overheating, or for reducing the energy consumption under low thermal load conditions.

According to one embodiment, a plurality of fans could be arranged along the cooling duct. This configuration in series or in parallel could allow more precise modulation of the air flow through the heat exchanger and more uniform distribution of the temperature inside the duct.

According to one embodiment, the fan in the duct could be designed to operate in conjunction with a heat recovery system. By recovering some of the heat released by the electrical system and by reusing it for heating the cabin or defrosting the wings, for example, the overall energy efficiency of the aircraft could be improved.

According to one embodiment, the air inlet is located in an area of high natural pressure of the fuselage of the aircraft, without a direct impact from the propeller, while the air outlet is positioned in an area of low pressure generated by the propeller.

According to one embodiment, the air inlet is located in an area of overpressure generated by the propeller, while the air outlet is positioned in an area of low natural pressure of the fuselage of the aircraft without direct impact from the propeller.

According to one embodiment, there is no fan in the cooling duct.

According to one embodiment, the air inlet comprises an air filter to prevent the ingress of debris.

### BRIEF DESCRIPTION OF THE FIGURES

FIG. 1 shows an airplane according to an embodiment of the prior art.

FIG. 2 shows the cooling system according to an embodiment of the invention.

FIG. 3 shows a diagram corresponding to the operation of the cooling system according to an embodiment of the invention.

FIG. 4 shows a three-dimensional view of the cooling duct according to an embodiment of the invention.

FIG. 5 shows several types of air outlets in a nacelle according to the invention.

FIG. 6 shows several types of ducts according to the invention.

FIG. 7 shows the configuration of the cooling duct and of its internal elements by considering a fan upstream of the heat exchanger according to an embodiment of the invention.

FIG. 8 shows the configuration of the cooling duct and of its internal elements by considering several fans installed in parallel according to an embodiment of the invention.

### DETAILED DESCRIPTION OF THE INVENTION

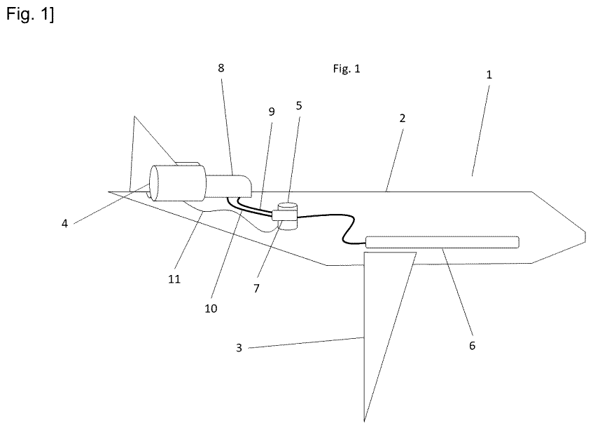

FIG. 1 shows an airplane 1.

The airplane comprises a fuselage 2, as well as wings 3. It is an airplane propelled by electric motors 4 powered via the cable 11 by electricity produced by a hydrogen fuel cell 5 powered by hydrogen stored in a tank 6.

The fuel cell 6 is cooled by a cooling system comprising a fuel cell cooling circuit 7, a cooling unit (heat exchanger) 8 and two pipes 9 and 10 for conveying a heat-transfer fluid between the unit 8 and the fuel cell cooling circuit 7. Thus, the first pipe 9 allows the heat-transfer fluid to be conveyed from the fuel cell cooling circuit 7 to the cooling unit 8. Conversely, the second pipe 10 allows the heat-transfer fluid to be conveyed from the cooling unit 8 to the fuel cell cooling circuit 7.

The fuel cell cooling circuit 7 is not specifically described. However, any fuel cell cooling circuit can be used. For example, provision can be made for the heat-transfer liquid to flow in the bipolar plates of the fuel cell. The contact between the heat-transfer fluid and the cells allows the thermal energy produced by the cells of the fuel cell 5 to be transferred.

The cooling unit 8 comprises a heat exchanger and a cooling duct. These elements will be described in further detail in the following figures.

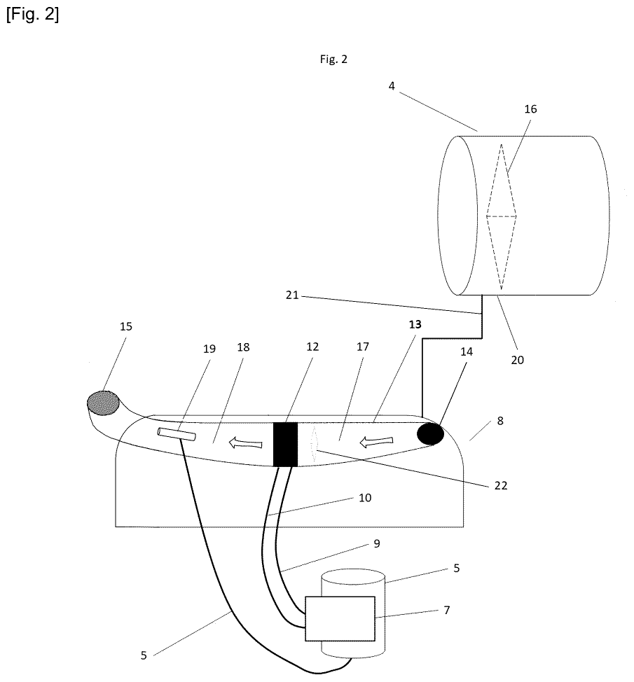

FIG. 2 shows the cooling system according to an embodiment of the invention.

The cooling unit 8 comprises an air/liquid heat exchanger 12 positioned in a cooling duct 13. The cooling duct 13 has an air inlet 14 and an air outlet 15.

The air inlet 14 is positioned so as to allow the outside air to enter the duct 13. The air inlet 14 is therefore positioned at a site of high pressure when the airplane advances, for example in the vicinity of the nose of the airplane or on one side, below or above the fuselage, or even on a wing, on a pylon holding a nacelle, etc. In the case of the embodiment described in FIGS. 1 and 2, the air inlet 14 is positioned above the fuselage at the base of the fin, and an area of overpressure generated by the propeller 16.

The air inlet 14 is positioned in an area of overpressure generated by the propeller 16.

The air outlet 15 is positioned so as to allow the air present in the duct 13 to be discharged. The air outlet 15 is therefore positioned at a site of lower pressure when the airplane advances and notably of lower pressure relative to the pressure at the air inlet 14. For example, the air outlet 15 can be arranged in the rear part of the airplane. In the case of the embodiment described in FIGS. 1 and 2, the air outlet 15 is positioned in the air flow generated by the propeller 16 so as to benefit from a venturi-type suction effect. More specifically, the air outlet 15 is positioned on the face of the fuselage in contact with the air flow generated by the propeller 16.

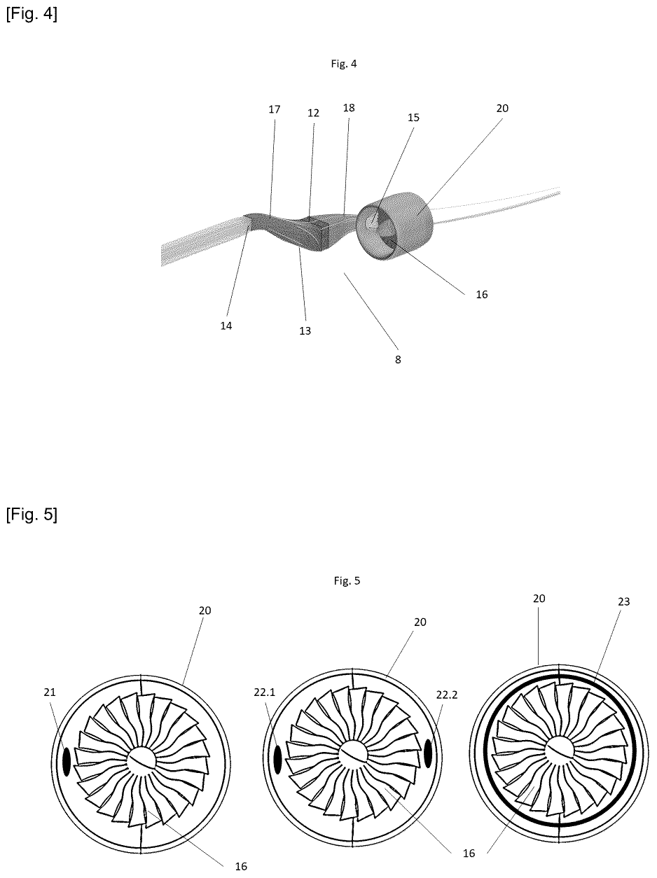

FIG. 5 describes the position of the air outlet 15 when it is positioned in the vicinity of the nacelle 20 in further detail. The nacelle 20 is an embodiment of the invention but is not necessary.

Thus, the cold outside air enters via the air inlet 14, passes through the upstream portion 17 of the duct 13 and then passes through the heat exchanger 12. The cold air in contact with the heat exchanger 12 is charged with thermal energy, i.e., the air heats up. Then, the hot air passes through the downstream portion 18 of the duct 13 in order to ultimately exit via the air outlet 15. The operating propeller 16 generates an overpressure at the air inlet 14 and therefore the air enters the duct 13 more quickly, which accelerates the flow of air in the duct 13. The operating propeller 16 generates a negative pressure in the vicinity of the air outlet 15. The air exiting the air outlet 15 is therefore sucked in by the air accelerated by the propeller 16, thus, the air is discharged outside the duct 13 more quickly, which accelerates the flow of air in the duct 13.

The reaction products originating from the fuel cell can be injected into the downstream portion 18 of the duct 13 under pressure. These products are conveyed by a pipe 5 to an injection device 19 arranged in the downstream portion 18 of the duct 13. The combustion products are injected in the direction of the flow of air in the cooling duct 13, namely from the air inlet 14 to the air outlet 15.

The cooling system described in FIGS. 1 and 2 is a cooling system based on a heat-transfer fluid that does not change phase. The cooling system can also rely on a phase-change fluid, in this case the cooling system comprises an evaporator placed in the vicinity of the fuel cell so as to transfer the thermal energy from the fuel cell to the heat-transfer fluid. Then the fluid in the vapor state passes through a condenser placed in the duct 13 instead of the air/liquid heat exchanger 12. The cooling system can also comprise an expansion valve for expanding the fluid or a turbine for extracting mechanical power [lacuna] a pump to allow the flow of the heat-transfer fluid. Then, the expanded gas again passes into the evaporator.

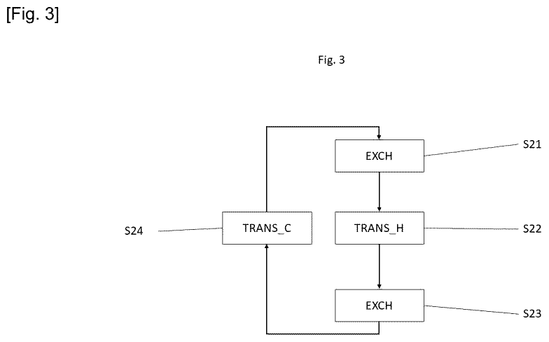

FIG. 3 shows a diagram corresponding to the cooling system.

In step S21, the heat-transfer liquid passes through the fuel cell cooling circuit 7. The temperature of the liquid increases and the liquid thus stores the thermal energy produced by the cells of the fuel cell 5.

In step S22, the hot heat-transfer liquid is conveyed via the pipe 9 to the heat exchanger 12 included in the cooling unit 8.

In step S23, the hot heat-transfer liquid is cooled in the heat exchanger 12 by virtue of the air flowing in the duct.

In step S24, the cold heat-transfer liquid is conveyed via the pipe 10 to the fuel cell cooling circuit 7.

Steps S21 to S24 are then repeated in a loop.

FIG. 4 shows a three-dimensional view of an embodiment of the cooling unit 8.

The same elements are shown as those described in FIG. 2, namely a duct 13 with an air inlet 14 and an air outlet 15. The heat exchanger 12 is positioned in the duct 13. The air outlet 15 is formed by the inner face of the nacelle 20 upstream of the propeller 16.

The air flow passing through the cooling duct 13 is shown by white strands. The air flow enters the duct 13 via the air inlet 14 and then passes through the upstream portion 17 of the duct 13. Then, the air flow passes through the heat exchanger 12 where it discharges the heat exchanger as thermal energy. The hot air flow then passes through the downstream portion 18 of the duct 13 in order to exit via the air outlet 15 that opens into the nacelle 20 in front of the propeller.

FIG. 5 shows several types of air outlets in the nacelle 20 according to the invention.

FIG. 5 more specifically shows the air outlet 15 in the inner face of the nacelle 20 that can assume several shapes and dimensions and can have several openings. The description of the preceding figures applies in this case.

In the three depictions, the nacelle 20 surrounds the propeller 16, more specifically the fairing of the nacelle 20. The area in the nacelle 20 that is present in front of the propeller 16 represents an area of negative pressure when the propeller 16 is operating. In the three examples, the openings 21, 22.1, 22.2 and 23 of each air outlet 15 (15, 15.1, 15.2, 15.3) are located in this area of negative pressure.

In the depiction of the nacelle on the left in FIG. 5, the air outlet 15 assumes the form of a single opening 21 in the inner face of the nacelle 20. This is simpler to design, but has the disadvantage of causing the propeller 16 to work in an asymmetrical manner and therefore of applying a stress on the axis of rotation of the propeller.

In the depiction of the nacelle in the center in FIG. 5, the air outlet 15 assumes the form of two openings 22.1 and 22.2 symmetrically located relative to one another relative to the axis of the propeller 16. This offers the advantage of balancing the pressure experienced by the propeller 16 and therefore of applying lower stresses on the axis of rotation of the propeller than in the case on the left. However, although the pressure is balanced relative to the axis of rotation of the propeller 16, the propeller 16 experiences variable pressures at an equal distance from the center of the propeller 16. This causes load distortions on the propeller 16.

In the depiction of the nacelle on the right in FIG. 5, the air outlet 15 assumes the form of a ring 23 located on the inner wall of the nacelle 20. This reduces the load distortions on the propeller 16.

The invention is not limited to these three types of air outlets 15.

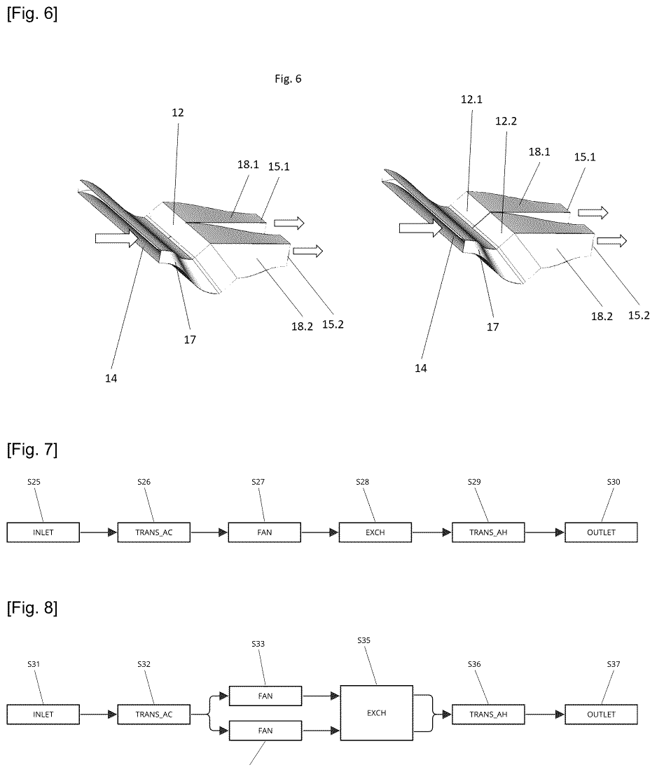

FIG. 6 shows two different shapes of ducts from that shown in FIG. 2.

The ducts shown in FIG. 6 have an air inlet 14 as previously described. This air inlet 14 can assume any shape. The air inlet 14 is connected to the upstream portion of the duct 17. However, the ducts have two air outlets 15.1 and 15.2 formed by a two-fold bifurcation of the duct.

More specifically, in the duct shown on the left in FIG. 6, a single heat exchanger 12 is provided. The air exiting the heat exchanger 12 is distributed in the two downstream portions 18.1 and 18.2 of the duct, each of these bifurcations has its own air outlet 15.1 and 15.2.

In the duct shown on the right in FIG. 6, two independent heat exchangers 12.1 and 12.2 are provided, one exchanger for each downstream portion 18.1 or 18.2 of the duct. At the outlet of the heat exchanger 12.1, the air passes into the downstream portion 18.1. At the outlet of the heat exchanger 12.2, the air passes into the downstream portion 18.2.

When the duct has two air outlets 12.1 and 12.2, as described in FIG. 6, each outlet can be positioned on a different nacelle in the case of airplanes with two or more motors.

FIG. 7 shows a diagram corresponding to a configuration of the cooling duct for supplying a heat exchanger with a fan.

In step S25, the fresh air enters the cooling duct from outside through the air inlet.

In step S26, the fresh air flows into the air duct.

In step S27, the fan pushes the air to enter the heat exchanger.

In step S28, the air passes through the exchanger and, by exchanging heat with the heat-transfer liquid, the air is heated.

In step S29, the hot air flows through the cooling duct toward the outlet.

In step S30, the air is expelled outside the aircraft through the air outlet.

Steps S25 to S30 occur through an open circuit.

FIG. 8 shows a diagram corresponding to a configuration of the cooling duct for supplying a heat exchanger using two fans installed in parallel.

In step S31, the air sucked in by the fans S33 and S34 enters the cooling duct through the air inlet.

In step S32, the air passes through the cooling duct.

In steps S33 and S34, the air is pushed by the fans.

In step S35, the air passes through the exchanger and, by exchanging heat with the heat-transfer liquid, the air is heated.

In step S36, the hot air flows through the cooling duct toward the outlet.

In step S337, the air is expelled outside the aircraft through the air outlet.

Steps S231 to S37 occur through an open circuit.

1. An aircraft comprising a cooling system integrated into the fuselage, and at least one propeller driven by an electric motor adapted to propel the aircraft, the cooling system comprising:
at least one cooling duct, installed inside the fuselage of the aircraft, provided with an air inlet and an air outlet, the cooling duct allowing air to flow between the air inlet and the air outlet;
at least one heat exchanger positioned inside the cooling duct, the heat exchanger transferring thermal energy to the air flowing in the cooling duct;
wherein the air inlet is positioned in an area of overpressure generated by the air accelerated by the rotation of the propeller, and the air outlet is positioned on an outer surface of the fuselage passed over by the air flow accelerated by the rotation of the propeller, generating an area of lower pressure facilitating the flow of air through the cooling duct, thereby allowing efficient dissipation of heat through the heat exchanger.

2. The aircraft as claimed in claim 1, wherein the cooling system is used to cool a fuel cell system.

3. The aircraft as claimed in claim 1, wherein at least one fan is located inside the duct to facilitate the flow of air.

4. The aircraft as claimed in claim 1, wherein the cooling system comprises a plurality of heat exchangers placed at different locations on the cooling duct.

5. The aircraft as claimed in claim 1, wherein the air outlet is located in an area of low natural pressure of the fuselage of the aircraft in flight, without a direct impact on the air accelerated by the propeller.

6. The aircraft as claimed in claim 1, wherein the air inlet is located in an area of high natural pressure of the fuselage of the aircraft, without a direct impact from the propeller.

7. The aircraft as claimed in claim 1, further comprising a nacelle fairing where the propeller and the air inlet are positioned, the air inlet being positioned in an area of overpressure generated by the propeller in this nacelle fairing.

8. The aircraft as claimed in claim 1, wherein at least one cooling duct has a plurality of air inlets or a plurality of air outlets.

9. The aircraft as claimed in claim 1, wherein the air inlets and air outlets are controlled so as to control the air flow flowing in the duct.
